(19) United States
(12) Patent Application Publication
(10) Pub. No.: US 2010/0049487 A1
(43) Pub. Date: Feb. 25, 2010

(54) ASSESSMENT TOOL

(75) Inventors: Andrew J. Clifton, Bristol (GB); Catherine A. Phillips, Derby (GB); Nigel R. Bond, Bristol (GB); William Mezzullo, Winchester (GB); Purvi Bhundia, Ilford (GB)

Correspondence Address: OLIFF & BERRIDGE, PLC, P.O. BOX 320850, ALEXANDRIA, VA, 22320-4850, US

(73) Assignee: ROLLS-ROYCE PLC, London (GB)

(21) Appl. No.: 12/450,459

(22) PCT Filed: Apr. 25, 2008
(86) PCT No.: PCT/GB2008/001481

§ 371 Date: Oct. 27, 2009

(30) Foreign Application Priority Data
Apr. 27, 2007 (GB) 0708300.9

(51) Int. Cl. G06F 17/50

(52) U.S. Cl. 703/6

(57) ABSTRACT

There is provided a method comprising the steps of determining an environmental impact of a product by: identifying one or more processes performed during the life cycle of the product; selecting identifying at least one design parameter relating to a the product and being associated with the identified process or processes; representing each of the identified processes by a process model, the process model identifying interventions by the process on the environment; and quantifying the interventions of each process on the environment using the at least one design parameter; and determining at least one environmental impact of the product from the design parameter or parameters; and generating an output indicating the environmental impact of the product.

### TECHNICAL FIELD OF THE INVENTION

The invention relates to an assessment tool for determining the impact of a product on the environment throughout the complete life cycle of the product.

### BACKGROUND TO THE INVENTION

Design for Environment (DfE) is an engineering perspective that considers how the design of a product will influence the way that product impacts on the environment throughout its entire lifetime. Adopting a DfE strategy means examining the entire life cycle of the product with the aim of optimising the design to minimise any and all impacts caused to the environment during the product's life cycle.

The components of a DfE strategy can take many forms, including, designing for Resource Conservation, designing for Low Impact Materials, designing for Energy Efficiency, designing for Cleaner Production, or designing for Recyclability.

Whichever strategy is adopted, it is important that the considerations for DfE are implemented as early on in the design process as possible. This will maximise the options available to the design team when they consider how to implement their DfE strategy and minimise costs incurred through any necessary design changes. FIG. 1 shows how the degree of freedom and cost of changing a design change through a complete design process. It can be seen that as time passes, the freedom of design is increasingly restricted while cost of change increases.

The most important part of any DfE strategy is the ability to measure and compare the effect the strategy is having on a product's impact on the environment. Such measures are provided by DfE assessment, which can be either qualitative, or quantitative.

Possessing a DfE capability is becoming increasingly important, mainly due to the continued attention being paid to environmental concerns by national and international organisations. Agreements made by these organisations, such as the Kyoto protocol and the Montreal protocol, often result in the implementation of reduction targets and restrictive legislation.

In order to be able to achieve these targets, and to be able to abide by the legislation, organisations need to be aware of the impact their products have on the environment and implement strategies to minimise and control these impacts. Furthermore, the current trend with new legislation is a ‘polluter pays’ philosophy, which is where the producer of the product is responsible for its safe disposal at the end of its life. This emphasises the need for manufacturers to be aware and in control of the potential environmental impact caused by their products, not just during manufacture and use, but also throughout their entire life cycles. The capability to perform DfE assessments provides a means of monitoring and implementing measures that are designed to minimise the environmental impact caused during the entire life cycle of an organisation's products, thereby helping them to operate in accordance with environmental targets and legislation.

In addition to the basic need for a company to abide by legislation and policies, implemented by national and international governments and ruling organisations, there are also several other internal and external drivers that will make the capability to perform DfE assessments beneficial.

Customer Requirements: The increased levels of legislation surrounding the environment has lead many organisations to instigate purchasing policies that specify a requirement for an environmental assessment covering the whole life cycle of any equipment they procure. Such problems are designed to identify, assess and assist in the management of the environmental impacts caused throughout the life of equipment.

Streamlined Life Cycles that Minimise Environmental Impacts: By implementing a system, which allows an organisation to identify and minimise the environmental impacts caused during the life cycle of their products, a capability is provided that will allow that organisation to produce ‘cleaner and greener’ designs, which, with the current emphasis being placed on policies where the polluter pays, will result in an improved bottom line, by minimising the costs incurred through subsequent waste treatment and collection processes.

Life Cycle Costing: If the evaluation results provided by the DfE assessment tool can be directly attributed to a potential cost to the company then the values can be used to help quantify the effect of environmental impacts on product life cycle costs.

Substances and Materials Mapping: Implementing a DfE strategy and assessment process can provide an organisation with an opportunity to map the location of hazardous or high risk materials in their products and processes. This will provide the organisation with the capability to react much quicker to legislation such as REACH (Registration, Evaluation, Authorisation, and restriction of Chemicals), which requires all substances used by a company to be registered for each of their different applications.

Commitment to the Environment: By implementing a DfE strategy, a company will be able to demonstrate that it is committed to minimising the impact it causes to the environment, a stance that will benefit the company through potentially influencing the choices of investors and customers.

Competitive Advantage: With the increasing demand for cleaner and greener products, the ability to quantify and minimise the environmental footprint of a product will give an organisation a significant competitive advantage over rival organisations that lack the same capability.

### SUMMARY OF THE INVENTION

It has been established that companies have a need for a DfE assessment tool to allow them to fulfill the requirements placed on them from both the internal and external drivers identified above. In order to maximise the benefits, the specification for such a tool needs to include a requirement for the tool to be able to identify and quantify some or all of the potential environmental impacts, caused during the entire life cycle of the product being assessed, and a requirement for the tool to be able to complete this assessment as early on as possible in the design and development phase.

In order to provide these functions, a tool is provided that is able to link basic parameters that are known in the early stages of design, such as material type and component dimensions, to the type and quantity of environmental impacts caused. This provides a tool that can present information on the type and quantity of environmental impacts, simply by considering basic design information. This not only provides the benefits mentioned earlier, concerning early evaluation, but also provides the possibility for the tool to be linked directly to existing design software such as CAD packages.

Specifically, in accordance with a first aspect of the invention there is provided a method comprising determining an environmental impact of a product by identifying one or more processes performed during the life cycle of the product; identifying at least one design parameter relating to the product and being associated with the identified process or processes; representing each of the identified processes by a process model, the process model identifying interventions by the process on the environment; and quantifying the interventions of each process on the environment using the at least one design parameter; and generating an output indicating the environmental impact of the product.

In accordance with a second aspect of the invention, there is provided a method comprising the steps of identifying at least one process undertaken in the life cycle of the product; identifying at least one design parameter relating to the product; identifying and quantifying waste streams of the at least one process using the at least one design parameter, a waste stream comprising any input or output of the at least one process that does not form a physical part of the product as it exits the process; and determining the environmental impact of the product from the identified waste streams.

According to a third aspect of the invention, there is provided a method comprising the steps of representing the life cycle of a product as a plurality of processes performed during that life cycle; representing each of the plurality of processes by a respective process model, each process model identifying interventions by the process on the environment; quantifying the interventions on the environment using at least one design parameter of the product; and determining the environmental impact from the quantified interventions.

In accordance with further aspects of the invention, there is provided a computer program comprising program instructions for causing a computer to perform any of the methods described above.

In accordance with another aspect of the invention, there is provided a computer-readable medium comprising a computer program as described above.

In accordance with yet another aspect of the invention, there is provided an assessment tool for assessing the environmental impact of a product, the assessment tool comprising an interface for allowing the input of at least one design parameter relating to the product; a modeling stage for determining at least one environmental impact of the product in accordance with any of the methods described above; and an output means for providing an indication of the environmental impact of the product.

In accordance with another aspect of the invention, there is provided a computer program for allowing a user to assess the environmental impact of a product, the program comprising computer executable instructions for causing a computer to generate a user interface, the user interface having at least one element for allowing the input of a design parameter for the product by a user; causing the computer to respond to the input of one or more design parameters by determining an environmental impact of a product by identifying one or more processes performed during the life cycle of the product; identifying at least one design parameter relating to the product and being associated with the identified process or processes; representing each of the identified processes by a process model, the process model identifying interventions by the process on the environment; and quantifying the interventions of each process on the environment using the at least one design parameter; and causing the computer to generate an output in the user interface that represents the determined environmental impact or impacts to the user.

### BRIEF DESCRIPTION OF THE DRAWINGS

The invention will now be described, by way of example only, with reference to the following drawings, in which:

FIG. 1 is a graph showing how design freedom and the cost to change the design changes through a design process;

FIG. 2 is a block diagram showing the operation of part of the tool according to the invention;

FIG. 3 is a block diagram showing the processes at each stage in the lifetime of a product;

FIG. 4 is a block diagram showing the tool in accordance with an embodiment of the invention;

FIG. 5 is a diagram showing the cause and effect chain for environmental damage;

FIG. 6 is a block diagram showing a Waste Stream Analogy of the process of making a cup of tea;

FIG. 7 is a block diagram showing a Relationship Model for quantifying a number of tea bags;

FIG. 8 is a block diagram showing a Relationship Model for quantifying an amount of electricity;

FIG. 9 is a block diagram showing the life cycle of a metal;

FIG. 10 is a block diagram showing an exemplary life cycle assessment for a product;

FIG. 11 shows four exemplary impact categories for an environmental impact;

FIG. 12 shows a characterisation model for climate change;

FIGS. 13, 14 and 15 are bar graphs showing the proportion of various resources by day-to-day and process specific operations for a facility;

FIG. 16 is a screen shot of a user interface used to evaluate and show the overall environmental impact of a component; and

FIGS. 17, 18 and 19 are screen shots of the user interface used to evaluate three processes used in manufacturing a component.

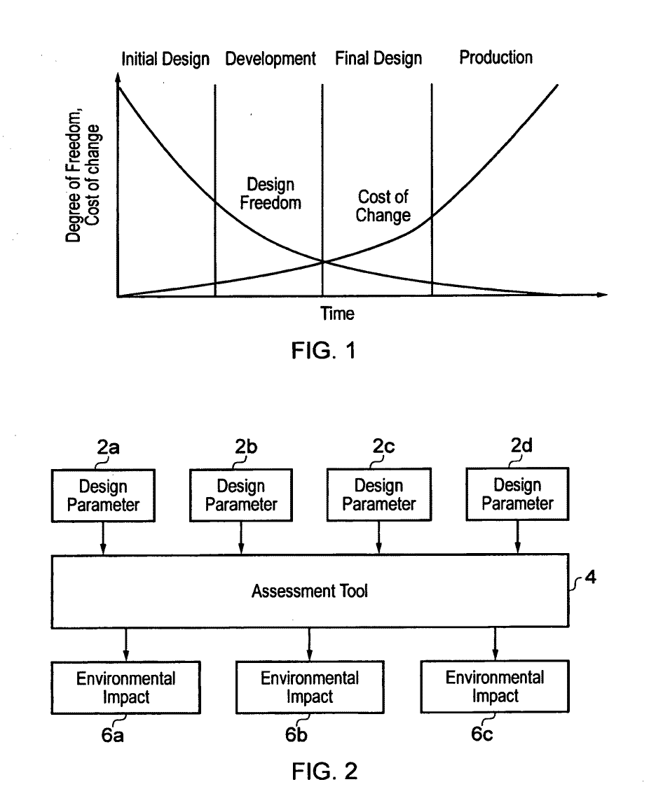

### DETAILED DESCRIPTION OF THE PREFERRED EMBODIMENTS

In order to fulfill the requirements stipulated in the proposed DfE tool specification a methodology has been constructed that will provide the required information using the specified data. A general summary of the methodology is presented below.

The methodology provides that the life cycle environmental impact of a product is a direct function of the processes that the product undertakes during its life cycle (for example forging, machining, maintenance operations etc) and the interactions those processes have with the natural mechanisms of the environment (for example, the release of substances into the atmosphere, water course or other environmental compartment, or the consumption of resources at a rate that exceeds their natural replenishment). The extent of the interaction, and therefore impact, varies according to the manner in which the individual processes are carried out, which in turn varies according to the specifics of the product's design.

The variations in the natural environmental mechanisms caused by these interactions will subsequently degrade environmental quality as measured by several key metrics, for example climate, toxicity levels, ozone depletion and abundance of resources.

The system described herein identifies and quantifies these interactions by evaluating the processes undertaken (or proposed, in the case of a design) during a product's life cycle by way of the waste streams the process creates. By identifying and quantifying the waste streams of the processes using the specific design characteristics of the product, the manner in which a given process interacts with the natural mechanisms of the environment can be determined. That is, each process model adjusts the type and magnitude of the waste streams for the respective process in accordance with the specific design parameters of the product. A design parameter is any parameter or attribute that is decided during the design of a product that influences its final shape, appearance, or function.

The impact on the environment caused by these interactions is then measured in two ways, first using a scientific metric and then using an integrated business metric. The scientific metric categorises each intervention in terms of in affect on several key measures for environmental quality (which are chosen to reflect the particular perspective of the industry associated with the product in question). The integrated business metric then categorises the effect the interactions and/or the scientific metric will have (or the risk that they will be an effect) on the business using accepted business metrics, which include but are not limited to cost, performance, profit etc.

FIG. 2 shows a very broad interpretation of the operation of part of the assessment tool in accordance with the invention. Essentially a number of design parameters 2a, 2b, 2c, 2d, or specific values for those design parameters, are input into the assessment tool 4, which determines the resulting environmental impacts 6a, 6b, 6c.

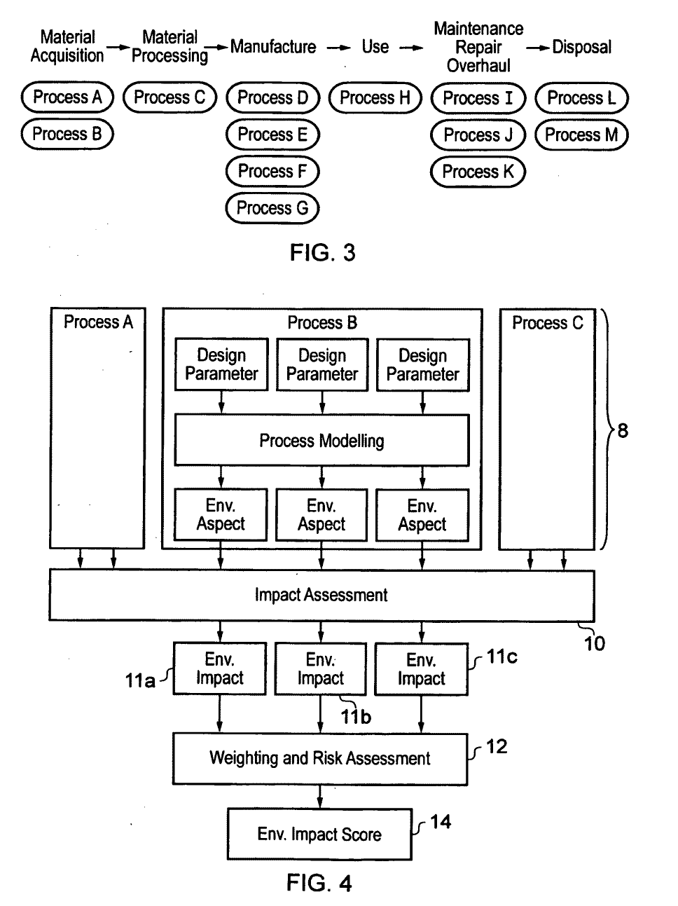

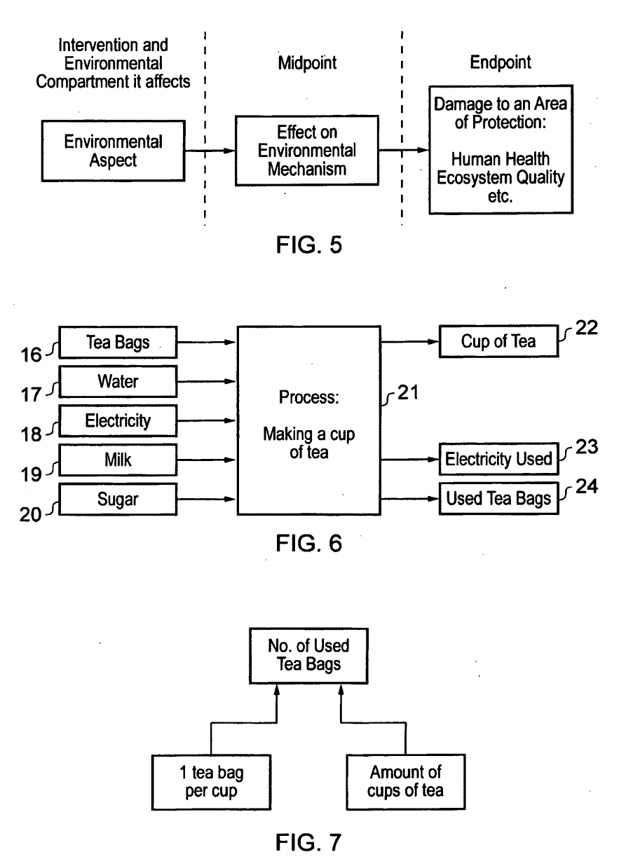

During a product's lifetime it will undergo multiple processes in order to fulfill its life cycle. Each of these processes will affect environmental quality by performing operations that will intervene into the natural mechanisms of the environment. These interventions, for example, can take the form of either the depletion of natural resources (such as ores, land etc) or the releasing of substances directly into an environmental compartment (soil, water or air). Such interventions, which are caused by a process, are referred to as the environmental aspects. These environmental aspects will form the first stage in a cause/effect chain (see FIG. 5 later) that will ultimately affect the quality of the environment. The combined types and quantities of environmental impacts, caused by the life cycle of a product, will therefore be a function of the specific types and quantities of processes that the product undergoes in order to fulfill its life cycle. FIG. 3 is a diagram showing an exemplary product life cycle. The life cycle has been divided into six main stages: material acquisition, material processing, manufacture, use, maintenance/repair/overhaul and disposal. For each stage in the life cycle, one or more relevant processes are identified.

The basis of one aspect of the invention is in representing each of the processes, which are available to be performed during the life cycle of a product, by process models, which are stored in a process database. Each of these process models identifies and quantifies all the environmental aspects of the process using only design parameters and process constants as the input variables.

All the environmental aspects created by the processes associated with the life cycle of the product are then combined, converted and quantified as specific types of environmental impacts by way of an Impact Assessment element. This is shown in FIG. 4.

For each of the identified processes (A, B, C etc) the relevant design parameters and their associated environmental aspects are identified in block 8. These environmental aspects are passed to an Impact Assessment block 10, which determines the environmental impacts 11a, 11b, 11c for each of the aspects.

Once all the aspects have been converted into a selection of representative impacts 11, the user has the opportunity to incorporate any elements of risk that may arise during the course of the product's life cycle, which may affect the assessment provided. This task is carried out by an additional Risk Assessment element 12 that incorporates a database of information including upcoming legislation changes, and a materials and process watch list.

The impact values, 11a, 11b, 11c, along with the optional risk elements, can then be weighted and converted into a potential cost and then combined to generate a single environmental impact score 14. This score can be measured in monetary terms and will represent the overall impact of the proposed design. This process is carried out using an optional weighting element that incorporates a list of weighting factors and cost factors that can be applied to the units of each impact category.

The functions of the tool according to the invention can therefore be divided into four elements, Process Modeling, Impact Assessment, Risk Assessment and Weightings.

The following provides the details of how each element of the invention functions.

Boundary Conditions

A set of boundary conditions are established in order to define what information is to be considered when determining the environmental impacts caused during a product's life cycle. The following conditions have been devised so as to simplify the modeling process, but it will be appreciated by a person skilled in the art that further or different conditions can be used.

The overriding condition is that the only impacts caused by a process that will be considered are the ones that occur when the process directly contributes to the life cycle of the product.

This condition includes the following assumptions:

When a process is modeled it will be assumed that any equipment required to operate the process is available and ready to use.

The environmental impact associated with producing minor consumables and substances can be considered only in terms of the effect on the depletion of resources used to produce them. The impacts associated with the production of major substances, such as alloys, can be considered in full.

The environmental impact caused by having to build any premises required to house operations used during the life cycle of the product will be ignored. The impact of running such premises can, however, be considered.

The impact caused by any transport associated with the life cycle of the product can be ignored.

Process Modeling

As described above, in order to understand the impact caused to the environment by a given process, the environmental aspects caused by the process are identified and assigned a value. This is because the information provided by an environmental aspect, which can consist of a substance type and the environmental compartment that will be influenced, will form the first stage in the cause and effect chain that will ultimately define a type of damage caused to one or more areas of the environment. An exemplary cause and effect chain can be seen in FIG. 5.

The methodology of the Process Modeling stage, takes design data and determines the type and magnitude of the environmental aspects caused by the operation of a process. The methodology incorporates several steps, each one helping to convert design data into quantified lists of the resulting environmental aspects. The following lists explains the various steps in this process.

Waste Stream Analogy (WSA)

A method to help identify and quantify the environmental aspects of a process using a combined Waste Stream Analogy (WSA) and Relationship Modeling (RM) approach has previously been suggested. The WSA step of this approach identifies the wastes that are created during the operation of the process, while the RM step links the quantity of the waste streams to the input of a specific design parameter or process constant. In the WSA approach, the process being evaluated is subjected to an inventory analysis in order to determine the inputs and outputs used and created during the operation of the process. Of these inventory items, the only desired item is the output of the product, all the other inputs and outputs of the process, which do not form a physical part of the product, are classified as waste streams.

FIG. 6 shows a Waste Stream Analogy applied to the process of making a cup of tea. In order to make the cup of tea the following inputs are required: a tea bag 16, some water 17, some electricity 18, some milk 19 and some sugar 20. The requirements of the kettle, tea pot and cup are not included as it is assumed that these items are available and ready to use, meaning they fall outside the boundary conditions established above. After the process 21, the desired output is the finished cup of tea 22, which incorporates the water, milk and sugar. Therefore the following waste streams can be identified: an amount of used electricity 23 and some used tea bags 24. The milk, sugar and water will become waste streams during the process of consuming the beverage in order to produce energy.

Relationship Modeling (RM)

In the RM stage of the methodology, the waste streams that have been identified are quantified by linking the amount of waste produced to one or more basic design parameters, process constants, or a combination of the two.

FIG. 7 show a relationship model for the “cup of tea” example above. The number of tea bags 25 in the tea bag waste stream 24 will be a function of two design parameters, one that defines the number of tea bags required per cup of tea 26, and one that specifies the number of cups of tea required 27. By multiplying these two values together the quantity of the tea bag waste stream 24 can be determined.

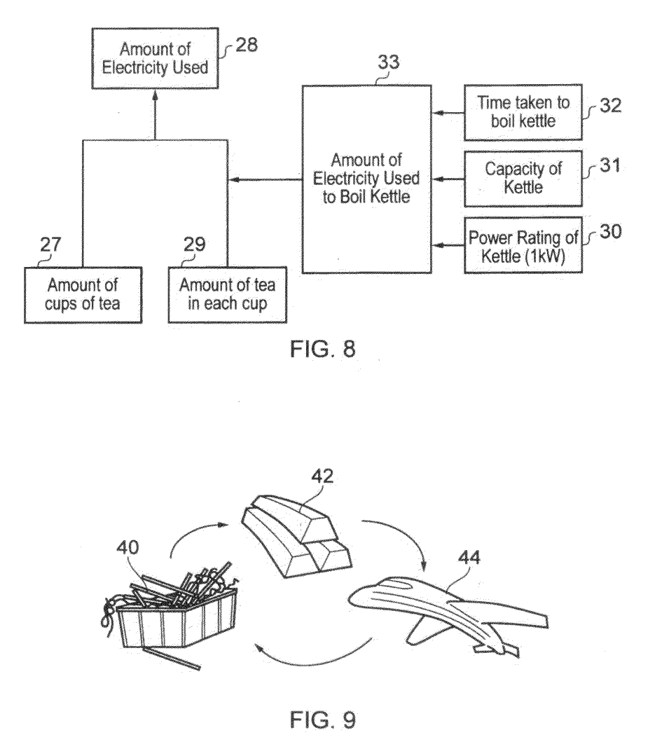

FIG. 8 shows another relationship model for the “cup of tea” example above. The amount of electricity 28 used to make the required number of cups of tea 27 will be a function of the process constants that define the power rating of the kettle 30, the capacity of the kettle 31 and the time it takes to boil the water in a full kettle 32. Combining these process constants will provide a value of the amount of electricity required to boil a given amount of water for this process.

The design parameters, which specify the number of cups of tea required 27 and the amount of water required per cup of tea 29, will then define the amount of water needed for the process.

This value, divided by the amount of water contained in a full kettle, and multiplied by the amount of electricity used to boil one full kettle 33, will determine the amount of electricity 28 required to boil the amount of water used by the process.

Determining Environmental Aspects from Waste Streams

Once the waste streams have been identified and quantified they need to be converted into environmental aspects. In accordance with an aspect of the invention, the technique for determining environmental aspects from waste stream data obtained through the WSA and RM approach involves analysing the life cycle of the waste stream to determine exactly what it is about the waste stream that will intervene into the natural mechanisms of the environment and therefore produce an environmental aspect. The first step in this technique is to classify what type of life cycle the waste stream possesses, in terms of which parts of it are carried out by separate processes. Four different categories of waste stream life cycle have been identified.

Category 1 Waste Streams: Integrated Life Cycle: When the life cycle of the waste stream takes place within the confines of the process that is being assessed, no further analysis of the waste stream is required and the waste stream will become the environmental aspect. This category will include all waste streams that are directly produced during the process and are also disposed of as part of the same process. For example, the water vapour produced when boiling a pot of water is produced as a by-product of the process and will be directly released into the air during the same process. The life cycle of this waste stream is therefore restricted to the confines of the water boiling process and any intervention it causes to the natural mechanisms of the environment can be taken into account when that process is modeled.

Category 2 Waste Streams: Integrated End of Life Cycle: When the substance that forms the waste stream is not initially produced during the process that creates the waste stream, but where the disposal of the waste stream is part of the operation of that process, the additional environmental effects of the production of that substance needs to be considered in order to fully account for all the environmental aspects produced. For example, if a process uses argon gas in its operation, but then subsequently releases the gas directly into the atmosphere, then the process for initially producing the argon gas needs to be considered if all the aspects associated with the argon gas waste stream are to be accounted for.

Category 3 Waste Streams: Integrated Production Life Cycle: If the substance that forms the waste stream is created as a by-product during the normal operation of the process that is being assessed, but is subsequently disposed of using a separate process, then the additional environmental effect of the disposal of the substance needs to be taken into account in order to determine all the environmental aspects. For example, any gases or vapours produced as part of a heat treatment or coating operation may be captured by an emission system and cleaned to reduce the hazard they pose to the environment. In this instance the process of cleaning the emissions needs to be considered in order to fully account for the environmental aspects produced by the creation of this category of waste stream.

Category 4 Waste Stream: Separate Life Cycle: In the circumstance where a substance, that forms a waste stream created by a process, is neither initially produced, or disposed of, as part of that process, the additional environmental effect of both the production and disposal processes of that substance needs to be taken into account in order to determine all the environmental aspects associated with creating that waste stream. For example, if the process involves machining a piece of steel, then a waste stream for the removed steel will be created. The environmental aspects of producing this waste stream will be a function of the process used to create the steel in the first place and the route by which it is disposed of.

To evaluate the production and disposal stages for waste stream substances that fall into any of Categories 2, 3 and 4, the processes employed in those two stages have to be modeled. These models are produced in exactly the same way as mentioned previously, namely using a combined WSA and RM approach. The majority of the waste streams produced by these models will contain waste streams that can be directly correlated to environmental aspects. However, some models may still contain Category 2, 3 and 4 waste streams that can not be immediately correlated, and in these circumstances the production or disposal stages of those waste streams will need to be modeled as before. This process of modeling the life cycle of waste streams continues until every stage of the life cycle of every waste stream is accounted for by a process model.

Disposal Models

There are currently four routes identified for disposing of a substance. Each of these routes will be represented by a model that will take the substance type and quantity to be disposed of and determine a set of waste streams. Since these waste streams will be directly released into an environmental compartment, and their production would have been considered in a previous model, they will fall into the first category of waste streams and can therefore be classed as environmental aspects.

Recycled: In order for a disposal to be classed as recycling, the substance that formed the waste stream has to be returned to the beginning of the cycle where it can be re-processed into the same grade and quality of material, such that it can be used again in the same process.

In this instance, no further impact will be caused, since any subsequent processing of the material, as part of the recycling process, will be part of the life cycle of a separate product.

Downcycled: In order for a disposal to be classed as downcycling, the substance that formed the waste stream needs to be re-processed into a lower grade and quality of material, such that it can be reused, but not in the same process as before.

With this disposal route, any further environmental impact caused by the re-processing of the substance as part of the downcycling process will be part of the life cycle of a separate product. However, to distinguish this route from the recycling route, and highlight the disadvantages of downcycling over recycling, it is necessary to add some pseudo environmental impacts to the model.

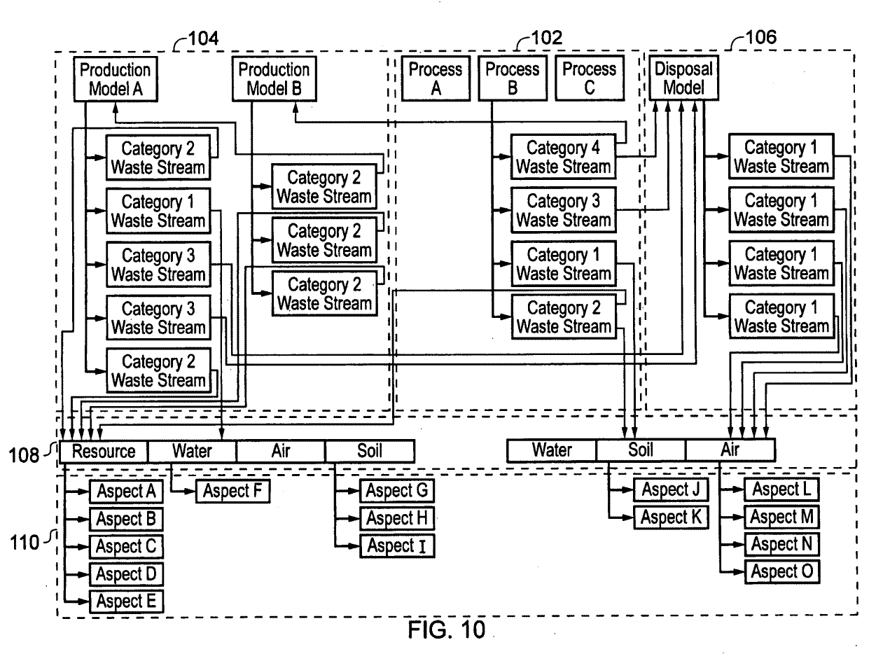

If the life cycle of a substance is considered, for example as shown in FIG. 9, it can be seen that substances and material that are constantly recycled will remain in a perpetual cycle within the life cycle of the product they are used with. In this example, scrap metal 40 is processed into a useful form 42, such as sheets or bars, and this is then used in building an aircraft 44. When the aircraft 44 reaches the end of its life, it is scrapped, producing scrap metal 40.

However, should any amount of this substance or material be removed from this cycle, for example by choosing to downcycle the substance, it will eventually need to be replaced with virgin material so that the quantity of the substance within the cycle is maintained.

In this respect, the pseudo impacts that are applied to the downcycling route take the form of a percentage of the impacts that will be caused by the production of the same amount of virgin substance. These impacts have been chosen so that they will be indicative of the impacts that will be incurred through having to eventually replace the substance that has been lost to a lower quality life cycle.

Incinerated: In order for a disposal to be classed as incineration, the substance that formed a waste stream of the process needs to be incinerated. By following this route the waste streams will be burned and will release several waste stream substances directly into the atmosphere. Since the waste streams of this process will be released directly into an environmental compartment they will convert directly to environmental aspects.

In order to discourage the practice of incineration, it is necessary to add some pseudo impacts to the overall impact incurred by choosing to incinerate waste. As with downcycling, these pseudo impacts are derived as a portion of the impacts that would be incurred through having to replace the incinerated material with virgin stock. Since the material that is incinerated is completely lost, this percentage is higher than that found in downcycling, but less than that found in landfill, due to the ability to reclaim some of the energy released during incineration.

Landfill: In order for a disposal to be considered as landfill, the substance that formed the waste stream of the process needs to be buried in a landfill. In this situation, the substance will effectively be released into the environmental soil compartment, allowing for it to be defined as an environmental aspect.

In order to discourage the practice of landfilling waste, it is necessary to add some pseudo impacts to the overall impact incurred by choosing landfill as a disposal route. As with the previous routes, these pseudo impacts are derived from the impacts that would be incurred through having to replace the landfilled material with virgin stock. Since the landfilled material is completely lost, the pseudo impacts consist of 100% the impacts that would be incurred through replacing 100% of the lost material with virgin stock.

Final Product Disposal

Final Product Disposal (FPD) is a separate process or stage in the life cycle of a product and therefore needs to be modeled separately. When a product is ready for final disposal, two steps need to be taken in order to ensure that all the environmental effects are accounted for.

1 The product must be broken down into its constituent elements: Up to this point, the environmental effect caused by the substances that formed a physical part of the product would not have been considered. This is because only the effect of waste streams are considered, and substances that form a physical part of a product are not considered as waste streams. However, now that the product is being disposed of, these substances will become waste streams, and in order to account for all the environmental effects of these substances, the product needs to be divided up into its constituent elements.

2 Assess the environmental effect of the constituent elements: Each of the constituent elements becomes a waste stream in the process of final disposal. In order to assess the environmental effect of these elements they are examined in the same way as other waste streams, i.e. in terms of their production and disposal.

By combining the stages of Waste Stream Analogy (WSA), Relationship Modeling (RM), and the techniques for combining life cycles, it is possible to generate a description of the life cycle of a product using process models. These models take basic design information and process constants and identify and quantify all the environmental aspects likely to be produced by the processes selected for the proposed life cycle.

FIG. 10 is a block diagram showing an exemplary life cycle assessment for a product. This block diagram loosely corresponds to block 8 in FIG. 4.

In FIG. 10, region 102 includes a representation of the life cycle of the product using process models. Region 104 illustrates the production models needed to represent the environmental effect of creating the substances in the waste streams of the process models. Region 106 illustrates the disposal model or models needed to represent the environmental effect of disposing of the substances in the waste streams of the process models. Region 108 shows how the waste streams that are created must eventually affect one of the four environmental compartments (emissions to soil, water, and air, and extractions of natural resources). Region 110 shows that once the waste streams are attributed to an environmental compartment, they can be considered as environmental aspects.

Thus, in this example, the life cycle of the product comprises three processes, Process A, B and C.

For clarity waste streams associated with Processes A and C in region 102 have not been shown in FIG. 10. However, the four waste streams for Process B generate fifteen environmental aspects when the necessary production and disposal models are assessed.

In this instance, the category 1 and 2 waste streams link to environmental aspects without further modeling, with the category 1 waste stream being associated with the soil environmental compartment 108, and the category 2 waste stream being associated with the resource and soil environmental compartments 108.

As described above, it is necessary to assess the aspects resulting from the production and disposal of the substance or substances in the category 4 waste stream. Thus Production Model B in region 104 sets out the model for the production of the substance in the category 4 waste in region 102. Production model B has three waste streams, each of category 2, which all link to an aspect in the soil environmental compartment 108. Two of these waste streams also link to a respective aspect in the resource environmental compartment 108.

However, the remaining category 2 waste stream for Production Model B includes a substance produced using a different process. Thus, this waste stream links to a production model for that substance, Production Model A.

Production Model A has five waste streams; a category 1 stream (with an aspect in the water environmental compartment 108); two category 2 streams (with respective aspects in the resource environmental compartment 108); and two category 3 waste streams.

The disposal of the substance or substances in these category 3 waste streams and the category 3 and 4 waste streams for Process B in region 102 are modeled by the Disposal Model in region 106.

The Disposal model produces four category 1 waste streams which result in four air compartment aspects.

Of course, FIG. 10 is an exemplary life cycle, and an actual product assessment may contain many more or fewer elements and aspects.

Impact Assessment

The information provided by combining the magnitude of the environmental aspects produced by the processes carried out during an entire life cycle will not immediately indicate a level of impact on the environment. In addition, the vastness of this information will often be too great to allow for any meaningful assessment to be carried out in a timely manner. The purpose of the Impact Assessment stage of the tool's methodology is therefore to link the information provided by the process modeling stage of the methodology to a meaningful measure of environmental impact, and also to condense the amount of information that is presented to the operator of the tool, such that they can quickly make a representative and informed assessment.

This is done using two metrics, the first is a scientific metric, which represents the actual magnitude of impact caused to the environment and is based on a midpoint approach. The second is a business metric, which represents the magnitude of the impact in terms of an actual of potential effect on the business, measured using standard business indicators, such as cost.

Midpoint Approach

The midpoint technique approaches the impact from the point of intervention and calculates the primary result of the creation of an environmental aspect by means of quantified impact categories. Each environmental aspect that occurs is linked to one or more specific environmental impact categories, which the aspect is known to contribute to. The magnitude of each aspect is then converted into a measure that represents a degree of impact for each of the impact categories it affects. The converted aspect magnitudes are then combined for each impact category to generate individual impact scores.

There are four elements to the midpoint assessment technique, which are based on the impact assessment guidelines given in ISO 14042—Life Cycle Assessment.

Selection: In order to begin a midpoint-based assessment, a series of relevant impact categories must first be selected. The selection is based on the areas of the environment where concern is expressed and a sufficient number of categories should be selected to account for each of these areas. Care should be taken that the selection does not contain any categories that overlap with one another, as this will result in the double counting of aspects.

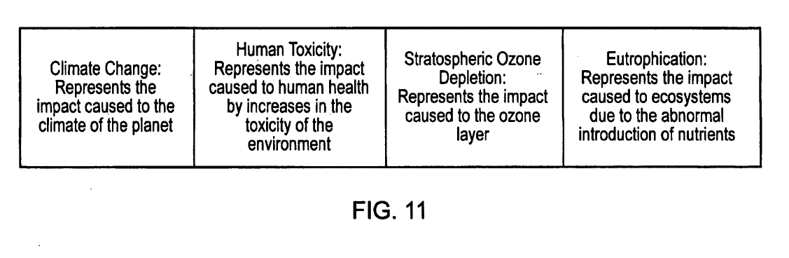

FIG. 11 shows four exemplary impact categories for an environmental impact. These are: Climate Change, Human Toxicity, Stratospheric Ozone Depletion and Eutrophication.

For each of the of the selected impact categories, an appropriate indicator, which will be used to measure a change in the level of impact, needs to be defined. For example, if the impact category “Climate Change” was selected, then the degree of impact could be measured using “Radiative Forcing” as the indicator, which is a measure of the effectiveness of a climate system to retain heat.

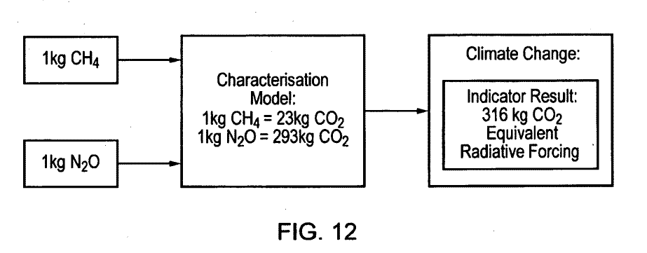

Each of the selected indicators, chosen for each of the specified impact categories, need to be accompanied by a characterisation model. These models are used to convert the magnitude of any aspect, attributed to the specified impact category, into an equivalent indicator value. For example to convert the magnitude of environmental aspects known to contribute to the impact category “Climate Change” into an equivalent value of “Radiative Forcing”, a characterisation model using “Global Warming Potential” could be used. This model will convert the magnitude of an aspect, which contributes to climate change, into a measure of the equivalent amount of CO₂ required to generate that degree of Radiative Forcing. This produces an Indicator Result measured in “kg of CO₂ Equivalents”. An exemplary model for climate change is shown in FIG. 12 for 1 kg of Methane (CH₄) and 1 kg of Nitrous Oxide (N₂O).

Classification: Once an appropriate selection of Impact categories, indicators and characterisation models has been made, the environmental aspects, identified by the process modeling stage, have to be assigned to their corresponding impact categories.

Characterisation: After attributing the list of environmental aspects to the appropriate impact categories, the magnitude of each environmental aspect is converted into an equivalent indicator value, which corresponds to the impact categories to which they are assigned.

This process results in a selective list of quantified environment impacts that represent the effect on various areas of the environment, caused by the creation of the identified environmental aspects, from a midpoint perspective.

Weighting: Each of the specific impact categories are weighted against each other in accordance with their perceived importance relative to one another. This step will generate weighting factors that are applied to each impact category. These factors represent the importance that has been placed on a particular type of impact and is based on the opinions and environmental perspective of a particular industry. The impact scores for each of the impact categories are then multiplied by their respective weighting factors to produce a list of quantified impacts, weighted towards the perspective of a particular industry.

Business Approach

In order for the environmental impacts to be acted upon, it is important that they are represented in terms of standard business metrics (for example cost), such that they are tradable with other metrics and allow for an integrated approach to decision-making that includes assessments of potential environmental impact. In order to represent the environmental impacts in this manner each environmental aspect, and environmental impact category, is reviewed to determine if there are any business restrictions associated to them which originate from internal or external drivers, such as costs, legislative measures, restrictions, recommended alternatives etc. This is done via a separate database, which holds all such information on the applicable environmental aspect, and selected environmental impact categories. Once the environmental aspects have been determined through the life cycle modeling stage of the methodology, and once these aspects have been attributed to the necessary environmental impacts through the midpoint based scientific impact assessment process, the identity and quantity of the environmental aspects and environmental impacts are fed through the database, which amalgamates the information to produce an overall assessment of the environmental impact of the product's life cycle in terms of standardised business metrics and the risks that may have an affect on the business or on the sustainability of the product's life cycle.

Risk Assessment

Due to the long life cycles of many types of products, there is a high probability that any environmental policies or legislations, which affect the level of impact attributed to a particular life cycle stage, could potentially change before the product reaches that stage in its life cycle. This causes a problem in that it limits the usefulness of the assessments provided by a standard environmental assessment tool. The DfE tool solves this problem by incorporating a Risk Assessment in the assessment process that will ‘pre-empt’ what legislations are likely to change over time and how that change will affect the environmental impact assessments provided by the tool. The Risk Assessment element incorporates a database of information, including upcoming legislation changes or fiscal measures (such as taxes and cap and trade schemes), and a materials and processes watch list. Should the life cycle under investigation use any processes or materials on the watch list, or use processes or generate environmental aspects that will be subject to new legislation, the Risk Assessment element will inform the operator by way of environmental statements and, where necessary, will adjust the impact values accordingly.

Facility Assessment

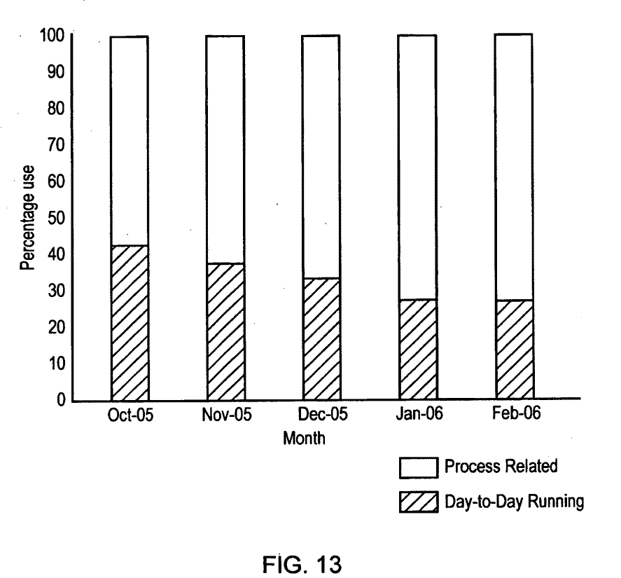

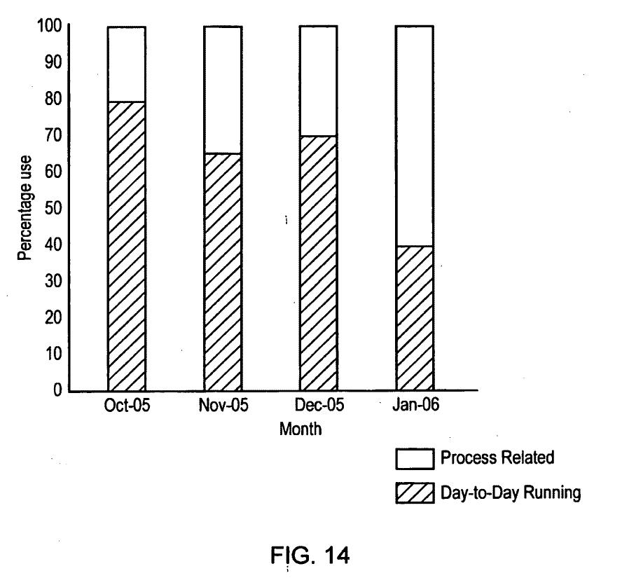

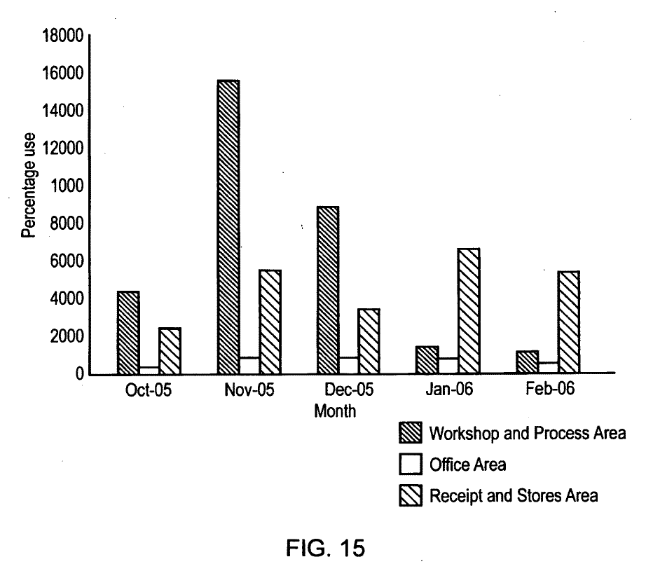

The impacts associated with the day-to-day running of a facility or building (such as heating and lighting), which is used during the operation of some life cycle processes, will account for a significant portion of the overall impact caused during the operation of that process. This can be seen in FIGS. 13 through 15, which depict the proportion of total resource use (electricity, water, and gas) that can be attributed to the day-to-day operations of a modern manufacturing facility.

In order to account for these impacts, the tool provides the option of including the day-to-day impacts caused by a selection of generic facility types. If the user decides that they would like to include the impacts associated with the day-to-day running of any facility used during the process they would like to model, then the tool will offer the option to include a series of impacts determined for a selection of generic facility types. Base values for the impacts will be predetermined and scaled according to the design parameters entered for the process being modeled. The user will only be required to select the most appropriate facility type from the selection list.

FIGS. 13 through 15 show the portion of each resource (electricity, water and gas respectively) used by day-to-day and process specific operations for an exemplary facility. These Figures show that the quantity of resource use attributed to day-to-day operations accounts for a significant portion of the total amount used by the exemplary facility in all its operations. This implies that the environmental impacts associated with the day-to-day running of a facility are significant enough to be considered when assessing the environmental impact caused during the entire life cycle of a product.

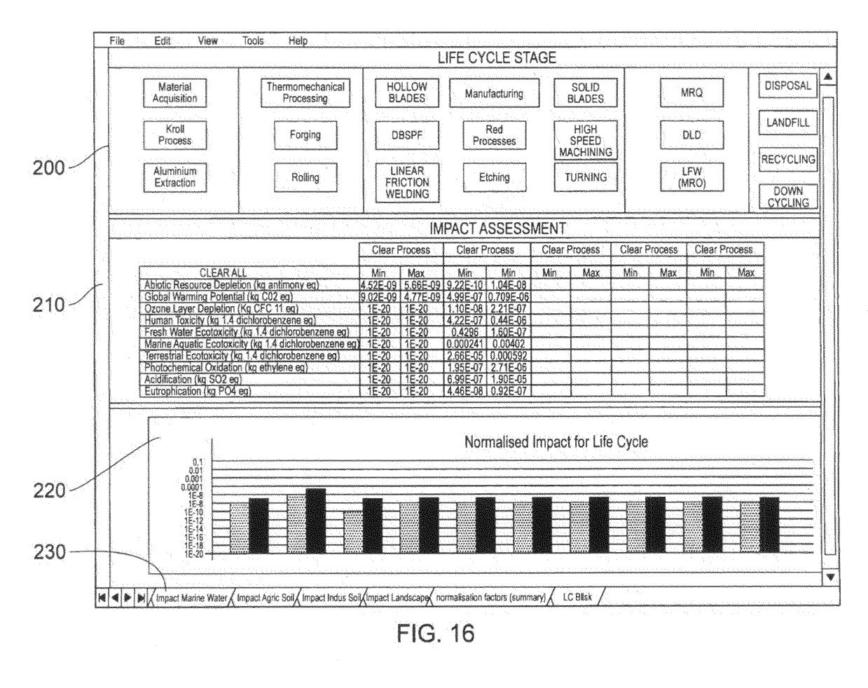

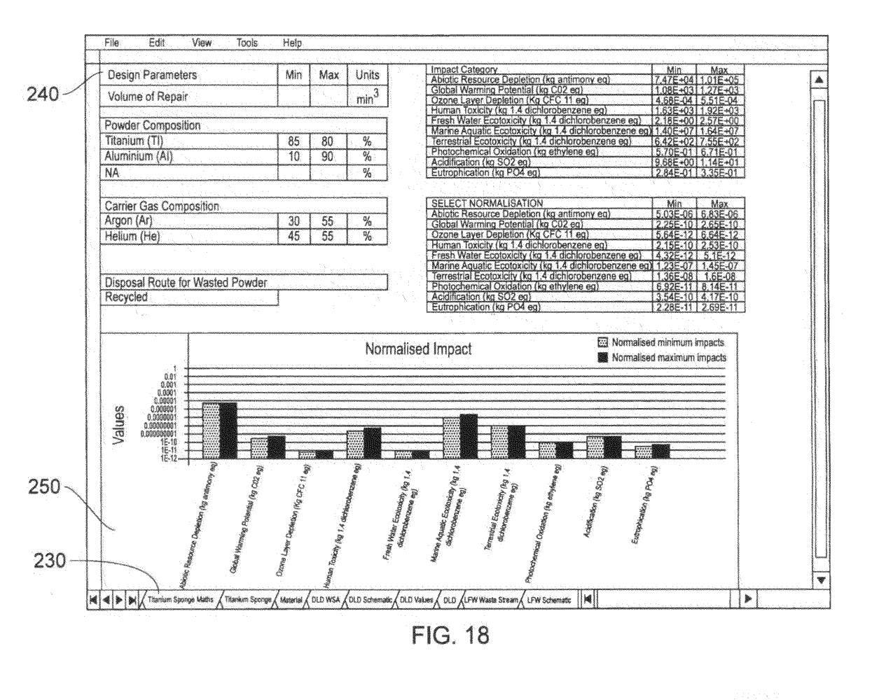

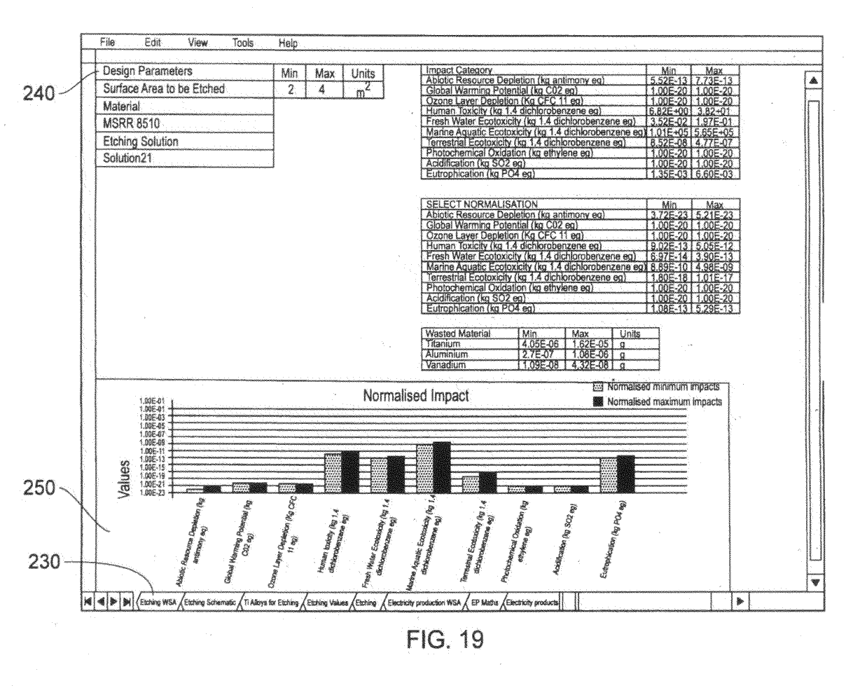

FIGS. 16 through 19 are screen shots of an exemplary assessment tool in accordance with the invention. In this embodiment, the assessment tool is implemented as a computer program for use on a conventional computer.

The program provides a visual and/or audible interface that allows a user to input design parameters and process details relating to a product, determines environmental aspects and impacts from the input parameters and which provides an output for the user representing the determined environmental impacts.

As will be appreciated, the computer program can be stored or embodied in any suitable medium, including, but not limited to, an optical or magnetic disk, or a solid-state memory device.

FIG. 16 shows the overall breakdown 200 of a life cycle of the product, and includes processes involved throughout the life cycle of the product. In the illustration processes involved at various life cycle stages are mentioned. At the top left side of the picture under the general heading Material Acquisition relevant processes employed in raw material acquisition are mentioned. In this instance, for example the Kroll Process, a pyro-metallurgical industrial process used to produce metallic titanium, invented in 1940 by William J. Kroll, and Aluminium Extraction. Next, in a section to the immediate right relevant material processes are listed under Thermo-mechanical Processing, for example Forging and Rolling. In the centre section actual product manufacturing processes relevant to manufacturing of the product itself are mentioned, in this example processes for the production of Hollow Blades and Solid Blades, which may involve investment casting for example. Also more advanced processes such as: Diffusion Bonding Super Plastic Forming (DBSPF), Linear Friction Welding, High Speed Machining for example grinding, and Turning. In the section next to the right are processes that could be employed either in finishing the product and/or during its working life cycle under the heading Maintenance, Repair and Overhaul (MRO), these include Direct Laser Deposition (DLD) and further Linear Friction Welding where a damaged part is removed and a replacement welded-on (LFW MRO). Finally and at the far right are the processes involved at the end of the product's useful life, such as Disposal, Landfill, Re-cycling and Down-cycling.

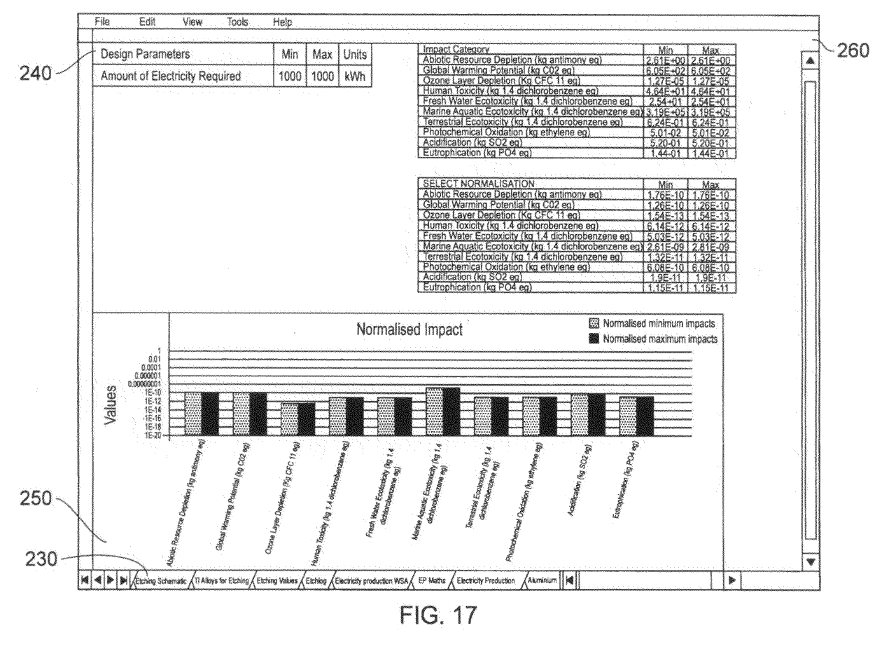

The processes involved at each stage in the life cycle can be selected, and a respective input/output screen can be displayed. Exemplary input/output screens for electricity production, direct laser deposition and etching are shown in FIGS. 17, 18 and 19 respectively. Once the input parameters are entered, the impacts are determined.

Below the life cycle stages 200, there is a table 210 that includes numerical values for the different environmental impacts identified from the life cycle stages.

Below the table 210, a graphical representation 220 of the environmental impacts is provided. In this embodiment, a bar graph 220 is provided, although it will be appreciated that any suitable type of visual representation can be used in accordance with the invention.

In order to form the bar graph, the numerical values are normalised, to allow easy comparison between the different impacts.

In addition, a number of tabs 230 are provided which allow a user to view different representations of the results, such as only viewing the impacts in a particular environmental compartment (marine water, agricultural soil, industrial soil, landscape, etc).

As described above, FIGS. 17, 18 and 19 show input/output shots for various processes. In each shot, a number of design parameters 240 specific to that process are shown. A user enters the appropriate values for that product and the resulting impacts for that process are shown in visual output 250. In addition, a table 260 is provided that shows the impact categories and minimum and maximum normalisation values.

The user interface of the assessment tool allows a user to vary the values of various design parameters in order to determine their effect on the determined environmental impacts. This can allow a user to design a product so that it satisfies a set of impact requirements.

There is therefore provided an assessment tool that develops process models using a combined Waste Stream Analogy (WSA) and Relationship Modeling (RM) approach; and that combines process models so that the environmental aspects produced during the entire life cycle of a product can be identified and quantified.

While the invention has been illustrated and described in detail in the drawings and foregoing description, such illustration and description are to be considered illustrative or exemplary and not restrictive; the invention is not limited to the disclosed embodiments.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A method comprising the steps of:
determining an environmental impact of a product by:
identifying one or more processes performed during the life cycle of the product;
identifying at least one design parameter relating to the product and being associated with the identified process or processes;
representing each of the identified processes by a process model, the process model identifying interventions by the process on the environment; and
quantifying the interventions of each process on the environment using the at least one design parameter; and
generating an output indicating the environmental impact of the product.

2. A method as claimed in claim 1, wherein the life cycle of the product includes one or more stages selected from a range representing stages in the life cycle of a product including material acquisition, material processing, manufacture, use, maintenance/repair/overhaul, and disposal.

3. A method as claimed in claim 1, wherein the step of quantifying the interventions of each process uses constants associated with said process.

4. A method as claimed in claim 3, further comprising assessing the quantified interventions to determine the at least one environmental impact of the product.

5. A method as claimed in claim 1, wherein the interventions on the environment are identified from analysis of waste streams of the processes, a waste stream comprising any input or output of the associated process that does not form part of the product.

6. A method as claimed in claim 5, further comprising the step of identifying interventions associated with the creation of an identified waste stream that is an input of the associated process.

7. A method as claimed in claim 6, wherein the step of identifying interventions associated with the creation of the identified waste streams comprises using one or more production models, each production model identifying the interventions in the process of creating the waste stream.

8. A method as claimed in claim 5, further comprising the step of identifying interventions associated with the disposal of an identified waste stream that is an output of the associated process.

9. A method as claimed in claim 8, wherein the step of identifying interventions associated with the disposal of the identified waste streams comprises using one or more disposal models, each disposal model identifying the interventions in the process of disposing of the waste stream.

10. A method as claimed in claim 1, further comprising the step of generating an environmental impact score from the one or more determined environmental impacts.

11. A method as claimed in claim 10, wherein the step of generating an environmental impact score comprises associating a weighting with each environmental impact; converting each impact into an indicator unit; and combining the weighted and converted impacts into the impact score.

12. A method as claimed in claim 10, wherein the step of generating an environmental impact score comprises associating an element of risk with each environmental impact.

13. (canceled)

14. A method comprising the steps of
identifying at least one process undertaken in the life cycle of the product;
identifying at least one design parameter relating to the product;
identifying and quantifying waste streams of the at least one process using the at least one design parameter, a waste stream comprising any input or output of the at least one process that does not form a physical part of the product as it exits the process; and
determining the environmental impact of the product from the identified waste streams.

15. A method as claimed in claim 14, wherein the step of determining the environmental impact comprises determining the environmental impact in terms of a direct effect on natural environmental mechanisms and/or business sustainability.

16-19. (canceled)

20. A computer-readable medium comprising a computer program for causing a computer to perform the method as claimed in claim 1.

21. An assessment tool for assessing the environmental impact of a product, the assessment tool comprising:
an interface for allowing the input of at least one design parameter relating to the product;
a modeling stage for determining at least one environmental impact of the product by:
identifying one or more processes performed during the life cycle of the product;
identifying at least one design parameter relating to the product and being associated with the identified process or processes;
representing each of the identified processes by a process model, the process model identifying interventions by the process on the environment; and
quantifying the interventions of each process on the environment using the at least one design parameter; and
an output means for providing an indication of the environmental impact of the product.

22-37. (canceled)

38. A computer program for allowing a user to assess the environmental impact of a product, the program comprising computer executable instructions for:
causing a computer to generate a user interface, the user interface having at least one element for allowing the input of a design parameter for the product by a user;
causing the computer to respond to the input of one or more design parameters by determining one or more environmental impacts of the product by:
identifying one or more processes performed during the life cycle of the product;
identifying at least one design parameter relating to the product and being associated with the identified process or processes;
representing each of the identified processes by a process model, the process model identifying interventions by the process on the environment; and
quantifying the interventions of each process on the environment using the at least one design parameter; and
causing the computer to generate an output in the user interface that represents the determined environmental impact or impacts to the user.

39. A computer program as claimed in claim 38, wherein the program further comprises computer executable instructions for:
allowing a user to input alternative design parameters for the product;
causing the computer to respond to the input of the alternative design parameters by re-evaluating the environmental impact of the product; and
causing the computer to regenerate the output in the user interface to represent the further determined impacts in addition to, or separate from, the previously determined impacts.
